(19) United States
(12) Patent Application Publication
(10) Pub. No.: US 2024/0301135 A1
(43) Pub. Date: Sep. 12, 2024

(54) POLYCARBONATE AND PREPARATION METHOD THEREFOR AND APPLICATION THEREOF

(71) Applicant: INSTITUTE OF PROCESS ENGINEERING, CHINESE ACADEMY OF SCIENCES, Beijing (CN)

(72) Inventors: Fei XU, Beijing (CN); Heng WANG, Beijing (CN); Suojiang ZHANH, Beijing (CN); Zhengkai LI, Beijing (CN); Zhencai ZHANG, Beijing (CN)

(73) Assignee: INSTITUTE OF PROCESS ENGINEERING, CHINESE ACADEMY OF SCIENCES, Beijing (CN)

(21) Appl. No.: 18/575,118

(22) PCT Filed: Jul. 28, 2022
(86) PCT No.: PCT/CN2022/108536

§ 371 Date: Dec. 28, 2023

(30) Foreign Application Priority Data
Aug. 6, 2021 (CN) 202110900336.3

(51) Int. Cl. C08G 64/08; C08G 64/30; G02B 1/04

(52) U.S. Cl. CPC C08G 64/081; C08G 64/305; G02B 1/04

(57) ABSTRACT

Disclosed are a polycarbonate and a preparation method therefor and an application thereof. The polycarbonate comprises at least one of structural units selected from a structural unit represented by formula (I) and a structural unit represented by formula (II). The polycarbonate provided by the present application has a high refractive index, and the obtained polycarbonate has a refractive index of 1.673-1.794, which can satisfy performance requirements of polycarbonate as an optical resin in optical components.

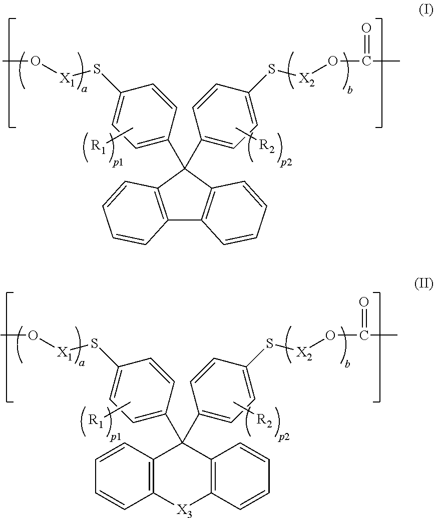

### TECHNICAL FIELD

Examples of the present application relate to the field of optical materials, for example, a polycarbonate, a preparation method therefor and an application thereof.

### BACKGROUND

Optical lens materials mainly comprise an optical glass and an optical resin. However, the optical glass has disadvantages such as high cost, poor molding processability, poor water resistance and poor heat stability, which limit its large-scale application in optical lenses. In contrast, the optical resin has the advantages of low cost, good processability, and thin shape and light weight, which has a broader application prospect.

In recent years, the trend of electronic products towards lightweight has put forward higher requirements for the development of optical lenses with high refractive index. Polycarbonate, as an engineering plastic with excellent comprehensive performance, not only has good dimensional stability, heat resistance and mechanical performance, but also is colorless and transparent, which is a widely used optical resin. The conventional bisphenol A polycarbonate has a refractive index of only 1.58, which has better optical performance compared with polymethyl methacrylate or polystyrene, but no longer meets the optical performance requirements of some high-end electronic products. Therefore, it is of great research value to develop an optical resin based on polycarbonate material.

CN103476825A discloses a thermoplastic resin composed of a fluorene derivative, and the polycarbonate resin comprises a structural unit of fluorene ring, which can be subjected to injection molding to obtain optical lenses or prisms, optical discs, optical fibers, optical films, or other optical components with excellent color appearance, but the refractive index cannot be more than 1.64. In addition to optical performance, in the molding process, the polycarbonate material is required to be subjected to a secondary high-temperature treatment, which has a high requirement for the high-temperature stability of materials. Therefore, with the increasingly higher performance requirements of the optical resin material and the gradually diversified application scenarios, it is of great significance to develop a polycarbonate material with high refractive index and high thermal stability.

### SUMMARY

The following is a summary of the subject described in detail herein. This summary is not intended to limit the protection scope of the claims.

Examples of the present application provide a polycarbonate, and the polycarbonate has excellent performance such as high refractive index and high thermal stability, and the maximum refractive index can be 1.794, which can meet the performance requirements of polycarbonate as an optical resin in optical components; examples of the present application also provide a preparation method for polycarbonate, and in the preparation method, diaryl or dialkyl carbonate and a dihydroxyl compound are used as raw materials and subjected to a melt transesterification reaction under the action of a catalyst and subjected to polycondensation to produce polycarbonate; by the preparation method, the polycarbonate with high refractive index, high thermal stability and adjustable molecular weight can be easily obtained, and the usage amount of the catalyst is small, reaction conditions are mild, no environmental pollution is produced during the reaction process, the product does not contain toxic substances, and the process is simple and convenient for large-scale production, and the preparation method is a high-efficiency and environment-friendly process for preparing polycarbonate; examples of the present application also provide an optical product, an optical product can be prepared from the synthetic polycarbonate, and the optical product has excellent performance such as high refractive index and high thermal stability.

An example of the present application adopts the following technical solutions:
a polycarbonate, which comprises at least one structural unit selected from a structural unit represented by Formula (I) and a structural unit represented by Formula (II):

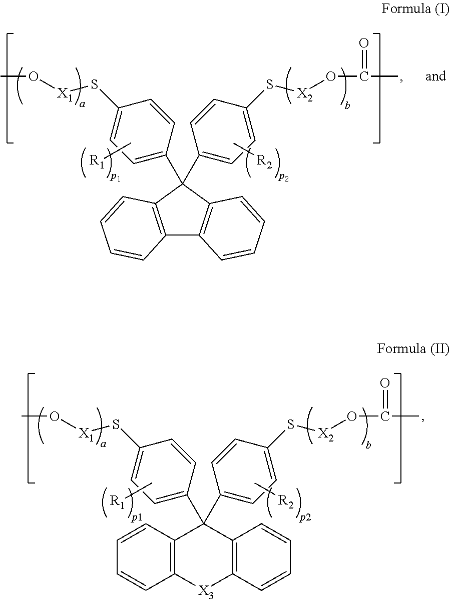

in Formula (I) and Formula (II), X₁ and X₂ each independently represent a substituted or unsubstituted, linear or branched, alkylene group having 1-8 carbon atoms; X₃ represents oxygen, sulfur, nitrogen, a carbonyl group, a substituted or unsubstituted, linear or linear, alkylene group having 1-10 carbon atoms, or a substituted or unsubstituted cycloalkylene group having 3-10 carbon atoms; R₁ and R₂ each independently represent hydrogen, halogen, a hydroxyl group, an ester group, a cyano group, an amino group, a thiol group, a substituted or unsubstituted, linear or branched, alkyl group having 1-6 carbon atoms, a substituted or unsubstituted cycloalkyl group having 3-10 carbon atoms, a substituted or unsubstituted olefin group having 2-6 carbon atoms, a substituted or unsubstituted alkoxy group having 1-6 carbon atoms, a substituted or unsubstituted, aryl or polycyclic aryl group having 6-30 carbon atoms, a substituted or unsubstituted, heteroaryl or polycyclic heteroaryl group having 3-30 carbon atoms, or an atom or atomic group which is used to replace the above groups; p1 and p2 are each independently selected from integers from 1 to 3; and a and b are each independently selected from integers from 0 to 5.

Specifically, in the structural units represented by Formula (I) and Formula (II) of the present application, the poly-aromatic ring structure is conducive to forming a planar structure, and the poly-conjugated structure can improve the optical refractive index of polycarbonate by increasing the molar refractive index of the molecular structure; the poly-aromatic ring structure has a high unsaturation degree, while the chemical performance of the molecular structure are abnormally stable, and therefore, the polycarbonate material has excellent thermal stability; more importantly, comparing sulfur heteroatom with oxygen atom, valence electrons of sulfur heteroatom are at the third energy level, and valence electrons of the oxygen atom are at the second energy level, and the sulfur atom has a larger volume, so that the heteroatom sulfur has a higher molar refractive index; on the other hand, the electronegativity of the heteroatom sulfur (2.5) is comparable to the electronegativity of the carbon atom (2.5) and less than the electronegativity of oxygen (3.5), and the sulfur has weak acting force in the aromatic ring substitution, which does not damage the planar action of the aromatic ring, and combined with higher molar refractive index, significantly improves the refractive index of polycarbonate. In this case, the polycarbonate in the present application can have both high refractive index and high thermal stability.

In the polycarbonate of the present application, based on a total number of moles of all repeating structural units of the polycarbonate, the at least one structural unit selected from the structural unit represented by Formula (I) and the structural unit represented by Formula (II) has a content proportion of 5-100 mol %.

Preferably, a structural formula of the polycarbonate is any one of Formulas (I-1) to (I-3) and Formulas (II-1) to (II-15), which, however, is not limited to the following structural formulas:

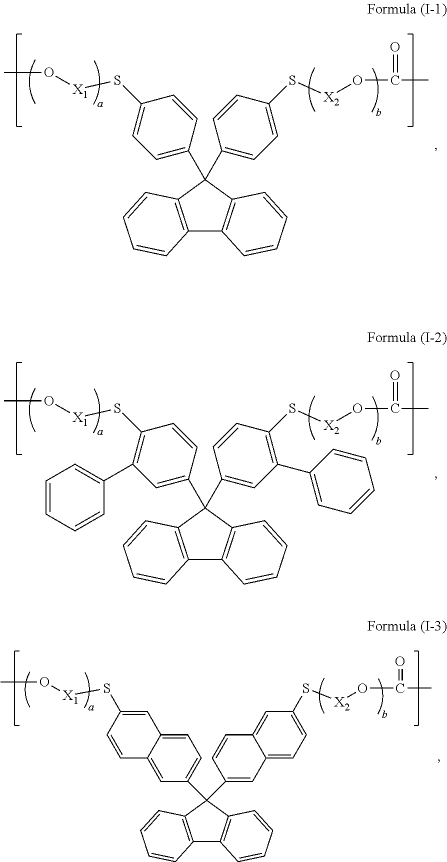

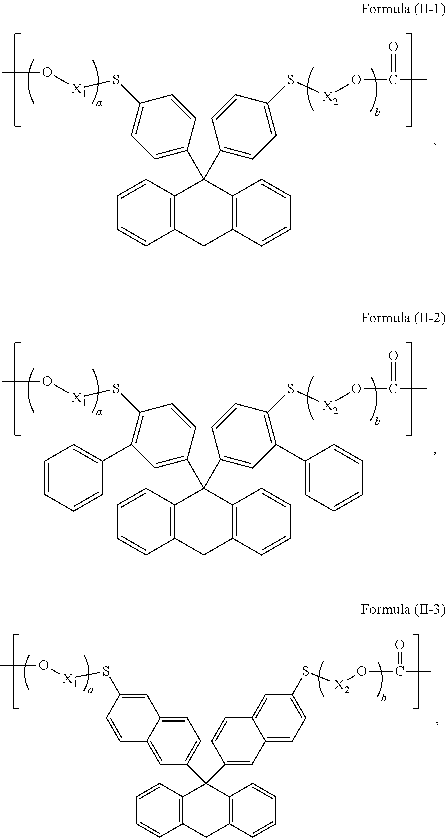

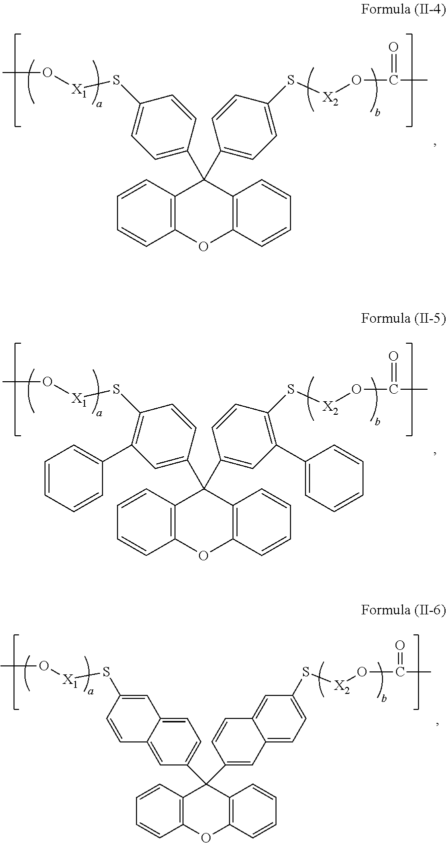

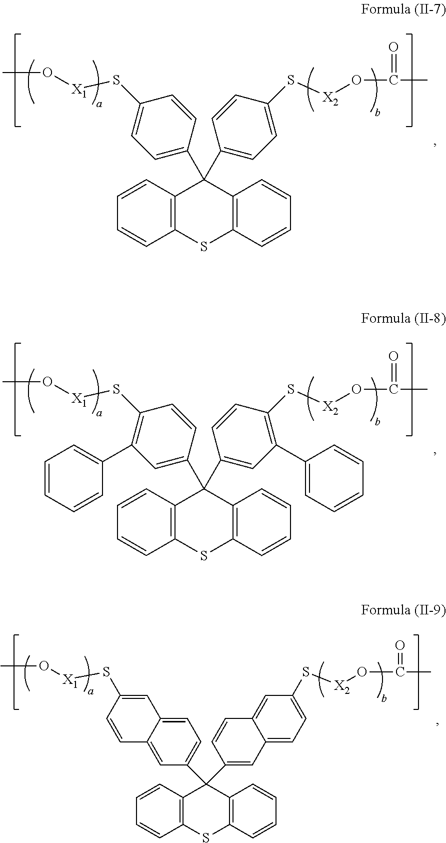

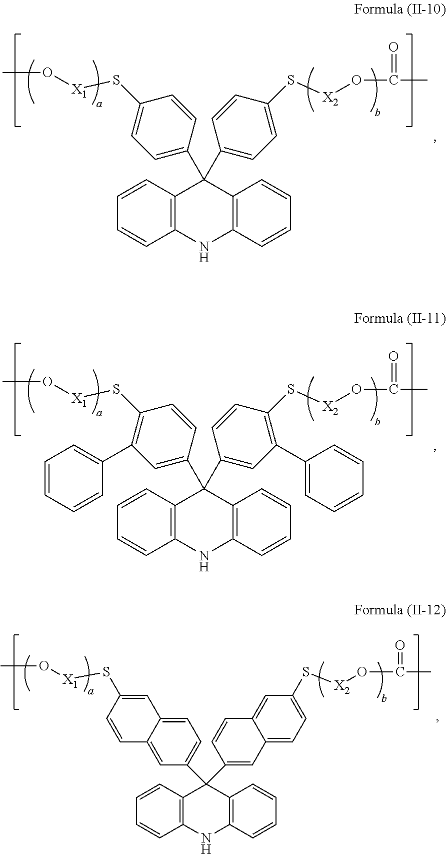

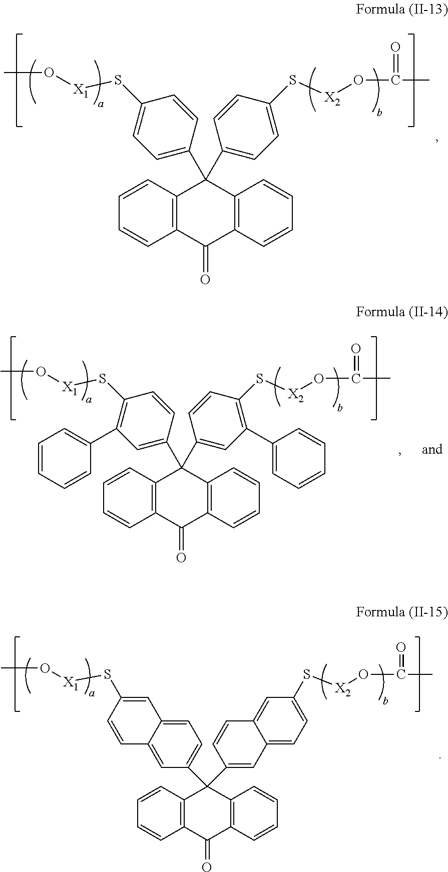

The polycarbonate further comprises a repeating structural unit represented by Formula (III) or Formula (IV):

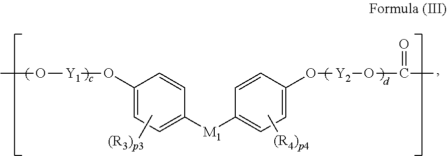

in Formula (III), Y₁ and Y₂ each independently represent a substituted or unsubstituted, linear or branched, alkylene group having 1-8 carbon atoms; c and d are each independently selected from integers from 0 to 5; M₁ independently represents any one of a single bond, O, S, a linear or linear alkylene group having 1-5 carbon atoms,

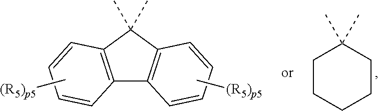

wherein a broken line represents a linkage site for a group; R₃, R₄, R₅ and R₆ are each independently selected from hydrogen, halogen, a hydroxyl group, an ester group, a cyano group, an amino group, a thiol group, a substituted or unsubstituted, linear or branched, alkyl group having 1-6 carbon atoms, a substituted or unsubstituted cycloalkyl group having 3-10 carbon atoms, a substituted or unsubstituted olefin group having 2-6 carbon atoms, a substituted or unsubstituted alkoxy group having 1-6 carbon atoms, a substituted or unsubstituted, aryl or polycyclic aryl group having 6-30 carbon atoms, a substituted or unsubstituted, heteroaryl or polycyclic heteroaryl group having 3-30 carbon atoms, or an atom or atomic group which is used to replace the above groups; p3, p4, p5 and p6 are independently selected from integers from 1 to 3;

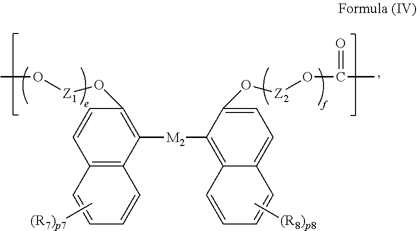

in Formula (IV), M₂ independently represents a single bond, O, and S; Z₁ and Z₂ each independently represent a substituted or unsubstituted, linear or branched, alkylene group having 1-8 carbon atoms; e and f are independently selected from integers from 0 to 5; R₇ and R₈ are each independently selected from hydrogen, halogen, a hydroxyl group, an ester group, a cyano group, an amino group, a thiol group, a substituted or unsubstituted, linear or branched, alkyl group having 1-6 carbon atoms, a substituted or unsubstituted cycloalkyl group having 3-10 carbon atoms, a substituted or unsubstituted olefin group having 2-6 carbon atoms, a substituted or unsubstituted alkoxy group having 1-6 carbon atoms, a substituted or unsubstituted, aryl or polycyclic aryl group having 6-30 carbon atoms, a substituted or unsubstituted, heteroaryl or polycyclic heteroaryl group having 3-30 carbon atoms, or an atom or atomic group which is used to replace the above groups; p7 and p8 are independently selected from integers from 1 to 3.

Preferably, a structural formula of the polycarbonate optical resin comprises any one of Formulas (III-1) to (III-3) and Formulas (IV-1) to (IV-2), which, however, is not limited to the following structural formulas:

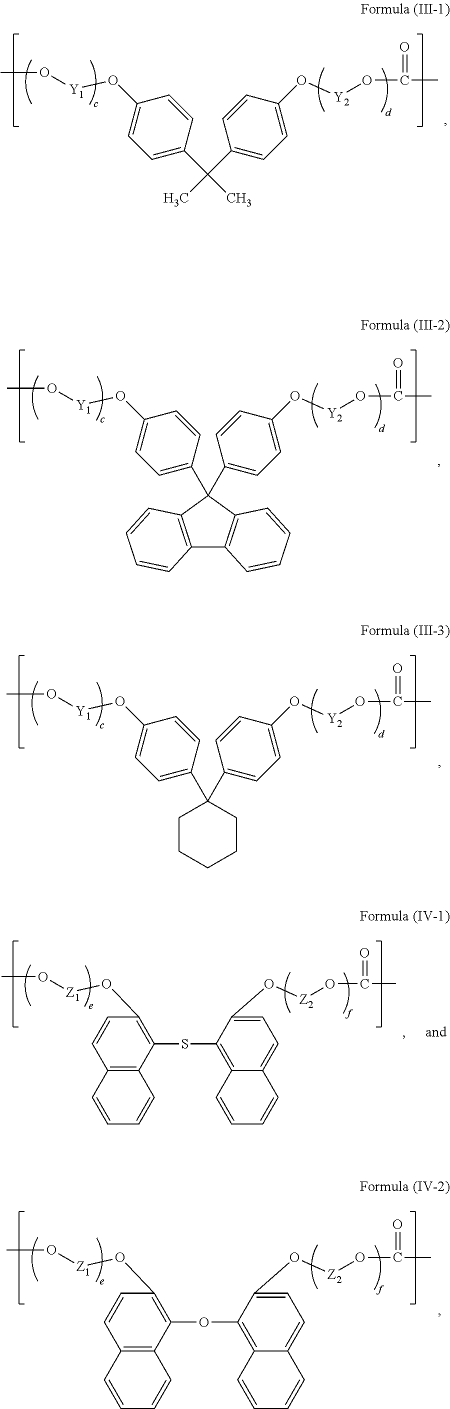

based on a total number of moles of all repeating structural units of the polycarbonate, the at least one structural unit selected from the structural unit represented by Formula (I) and the structural unit represented by Formula (II) has a content proportion of 30-85 mol %, and at least one structural unit selected from the structural unit represented by Formula (II) and the structural unit represented by Formula (IV) has a content proportion of 15-70 mol %. (Specifically, in structural units constituting the polycarbonate optical resin, a structural unit, which is inherited from at least one of a dihydroxyl compound having the structural unit represented by Formula (I) and a dihydroxyl compound having the structural unit represented by Formula (II), has a content of 30-85 mol % based on a total number of moles of all structural units which are inherited from the dihydroxyl compound, and a structural unit, which is inherited from at least one of a dihydroxyl compound having the structural unit represented by Formula (III) and a dihydroxyl compound having the structural unit represented by Formula (IV), has a content of 15-70 mol % based on a total number of moles of all structural units which are inherited from the dihydroxyl compound.)

The polycarbonate has a refractive index of 1.673-1.794 and a glass transition temperature of 135-200° C. which is further preferably 145-165° C. The polycarbonate in the present application has further improved refractive index and heat resistance.

A preparation method for the polycarbonate comprises the following steps: a dihydroxyl compound and diaryl or dialkyl carbonate are used as raw materials, wherein the dihydroxyl compound comprises at least one dihydroxyl compound selected from Formula (1), Formula (2), Formula (3) and Formula (4), and a polycarbonate is synthesized by melt transesterification and polycondensation reactions at atmospheric pressure in a nitrogen atmosphere; the preparation method comprises melting the raw materials, then heating to 120-190° C., and performing a transesterification reaction for 0.2-5 h by adding a catalyst to obtain a polycarbonate prepolymer; then gradually heating to 200-260° C., wherein a pressure of the reaction system is less than 50 Pa, and performing a polycondensation reaction for 0.2-5 h, so as to obtain a polycarbonate copolymer after the reaction, which has a weight average molecular weight of 3.0×104-21.6×104 g/mol; the polycarbonate in the present application has further improved excellent processibility, and the molecular weight of the polymer can be controlled by the regulation of different catalysts, so as to satisfy the requirements of different application scenarios and processing conditions.

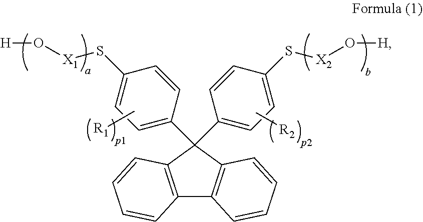

wherein X₁, X₂, R₁, R₂, p1, p2, a and b are each independently defined by the same limitation to Formula (I);

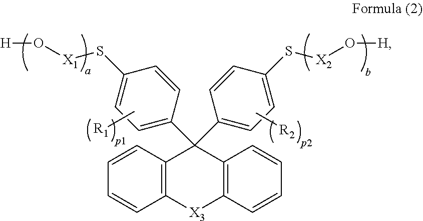

wherein X₁, X₂, X₃, R₁, R₂, p1, p2, a and b are each independently defined by the same limitation to Formula (I);

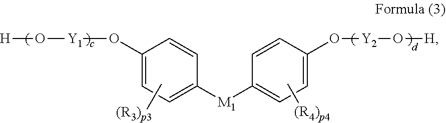

wherein M₁, Y₁, Y₂, R₃, R₄, p3, p4, c and d are each independently defined by the same limitation to Formula (III);

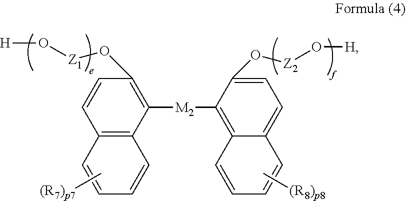

wherein M₂, Z₁, Z₂, R₇, R₈, p7, p8, e and f are each independently defined by the same limitation to Formula (IV).

Specifically, the structural formulas can be any one of Formulas (1-1) to (1-3), Formulas (2-1) to (2-15), Formulas (3-1) to (3-3) and Formulas (4-1) to (4-2), which, however, are not limited to the following structural formulas:

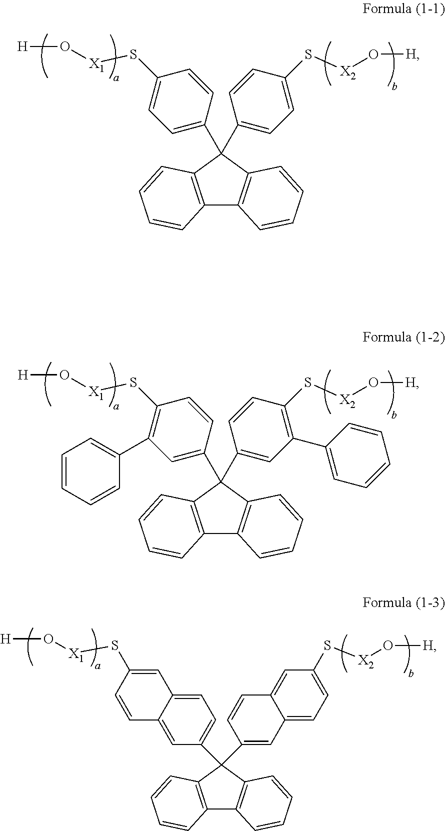

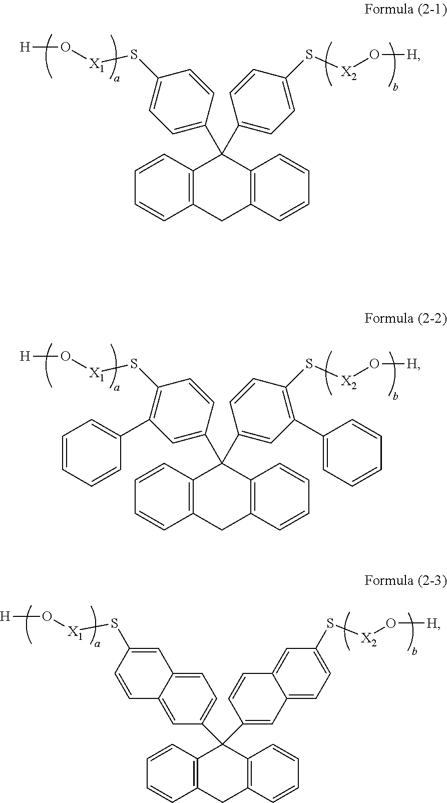

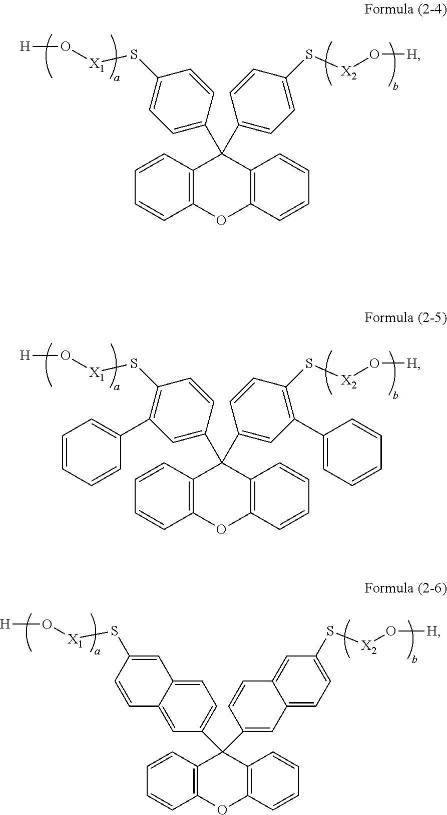

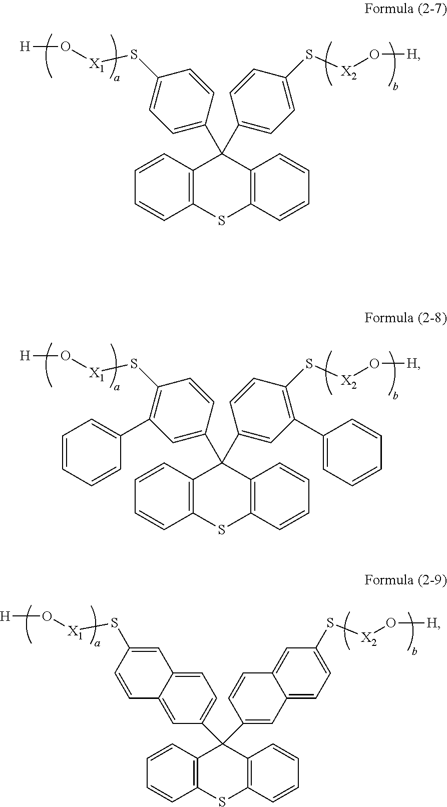

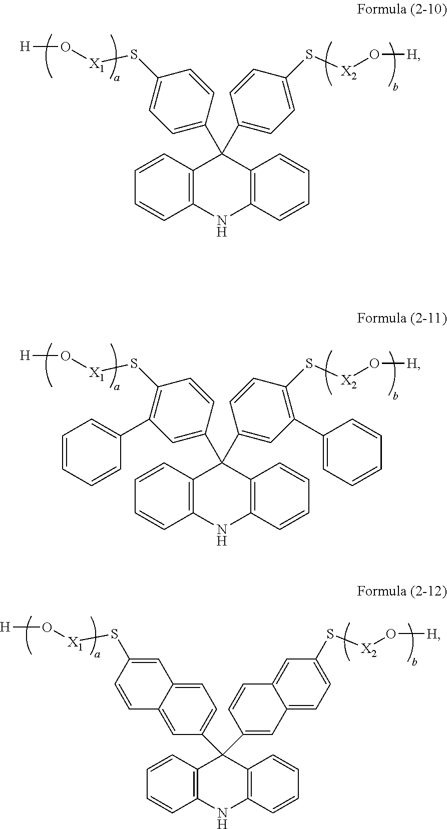

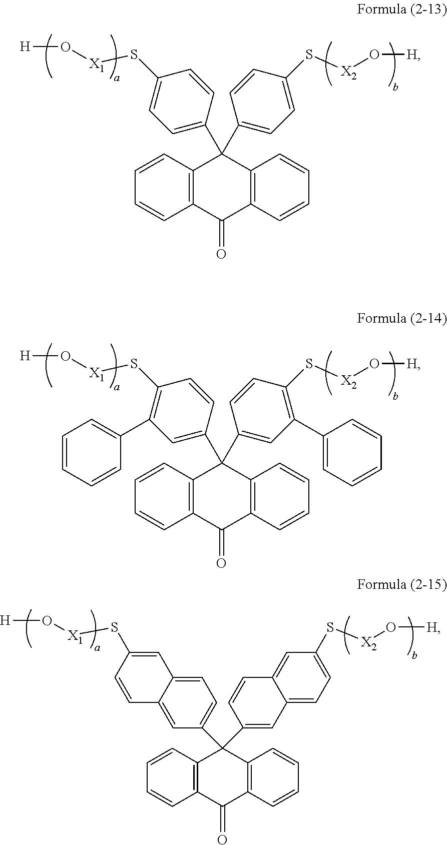

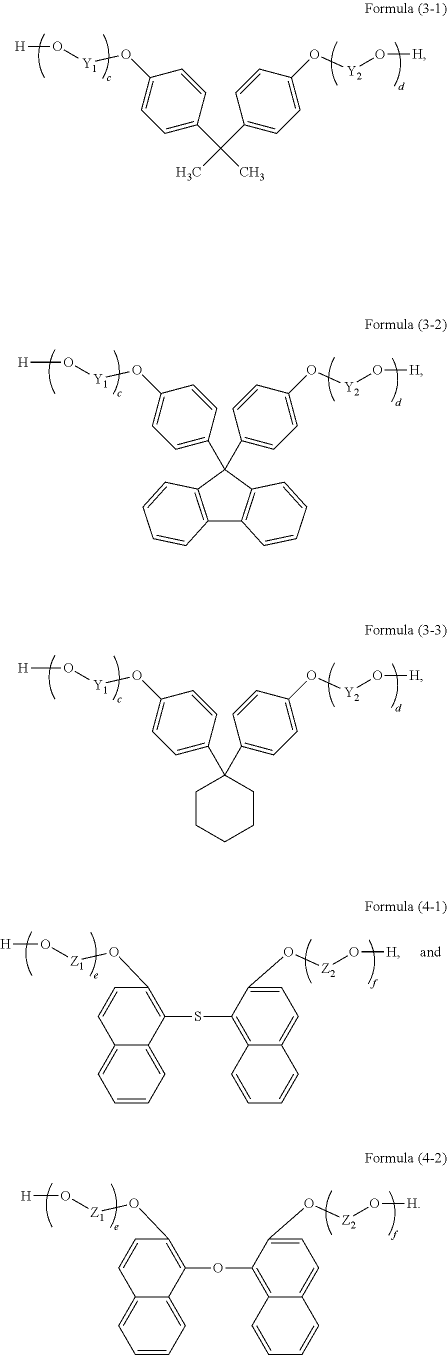

The catalyst is selected from an ionic liquid catalyst or a metal catalyst, wherein a cation in the ionic liquid catalyst is selected from any one of an imidazole cation, a quaternary ammonium cation, a quaternary phosphonium cation, a piperidine cation and a pyridine cation; the metal catalyst is at least one of lithium acetylacetonate, sodium acetylacetonate, potassium acetylacetonate, magnesium acetylacetonate, calcium acetylacetonate, zinc acetylacetonate, dibutyltin oxide, tetrabutyl titanate, tetraisopropyl titanate, a carbonate salt, an acetate salt, an alkali metal, an alkaline earth metal, 1,5,7-triazabicyclo[4.4.0]dec-5-ene (TBD) or 1,8-diazabicyclo[5.4.0]-7-undecene (DBU); a usage amount of the catalyst is 1×10⁻⁷-5×10⁻⁴ of an amount of substance of the diaryl or dialkyl carbonate compound;

the diaryl or dialkyl carbonate compound comprises any one or a combination of at least two of diphenyl carbonate, dimethyl carbonate, diethyl carbonate, dipropyl carbonate, dibutyl carbonate, dipentyl carbonate and dioctyl carbonate; the dihydroxyl compound comprises any one or a combination of at least two of Formula (1), Formula (2), Formula (3), Formula (4), isosorbide, isomannide, isoiditol, 1,5-pentanediol, 1,6-hexanediol, 1,7-heptanediol, 1,3-cyclopentanediol, 1,3-cyclohexanediol, 1,4-cyclohexanediol, 1,2-cyclohexanedimethanol, 1,4-cyclohexanedimethanol, diethylene glycol, triethylene glycol, tetraethylene glycol, hydrogenated dioleyl diol, 1,5-naphthalenedimethanol, 2,5-norbornanedimethanol or 4,8-bis(hydroxymethyl)tricyclodecane; a molar ratio of the dihydroxyl compound to the diaryl or dialkyl carbonate is 1:(0.97-5).

The polycarbonate in the present application optionally comprises an additive, and examples of the additive comprise but not limited to: an antioxidant, a plasticizer, an ageing resistant, a heat stabilizer, a filler, a dye, a light stabilizer, a ultraviolet absorber, a flame retardant, a antistatic agent, a release agent, and an anti-bacterial agent. These additives can be used alone or in any combination of two or more. The additive can be added with an appropriate amount according to requirements.

By the preparation method, the polycarbonate with high refractive index, high thermal stability and adjustable molecular weight can be easily obtained, the usage amount of the catalyst is small, reaction conditions are mild, no environmental pollution is produced during the reaction process, the product does not contain toxic substances, and the process is simple and convenient for large-scale production, which is a high-efficiency and environment-friendly process for preparing polycarbonate.

The polycarbonate has an application in optical components, electronic products, electrical equipment, packaging materials, medical apparatus or building materials.

An optical product is provided, which comprises the polycarbonate prepared in examples of the present application.

The beneficial effects of the examples of the present application are: the polycarbonate in the examples of the present application has excellent performance such as high refractive index and high thermal stability, and the polycarbonate can be prepared into an optical lens with good performance by processing, which can be applied in the fields of optical components, electronic products, electrical equipment, packaging materials, medical apparatus or building materials.

After reading and understanding the detailed description, other aspects can be understood.

### DETAILED DESCRIPTION

The technical solutions in the present application are described clearly and completely below in terms of examples of the present application; obviously, the described examples are merely partial examples of the present application, not all examples. Based on the examples of the present application, all other examples obtained by those of ordinary skill in the art without creative efforts shall fall within the protection scope of the present application.

Raw materials and preparation methods therefor used in the following examples and comparative examples of the present application are as follows:

2,2-bis(4-hydroxyphenyl)propane (BPA), 9,9-bis[4-(2-hydroxyethoxy)phenyl]fluorene (BPEF), 1,1′-bis[4-(2-hydroxyethoxy)phenyl]cyclohexane (BPEZ), 2,2-bis(2-hydroxyethoxy)-1,1′-thiobis(2-naphthol) (S-BNE) and other raw materials.

### Preparation Example 1

A synthesis route of 9,9-bis[4-(2-hydroxyethylthio)phenyl]fluorene (S-BPEF) is:

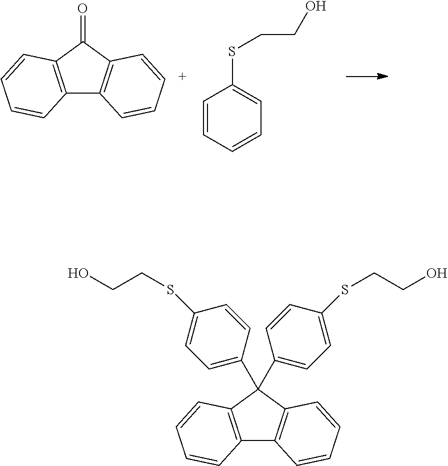

The 0.050 mol of 9-fluorenone, 0.300 mol of 2-(phenylthio)ethanol and 0.004 g of β-mercaptopropionic acid were weighed out. The reaction system was maintained in a nitrogen atmosphere. First, the reaction system was stirred at 40° C. until 9-fluorenone was completely dissolved, then 10.900 mL of concentrated sulfuric acid was added dropwise and the dropwise addition was completed within 0.5-1 h, and then the reaction system was heated to 65° C. and kept at the temperature to react for 5 h. After the reaction, a product was dissolved by adding 100 mL of toluene, stirred at 50° C. for 1 h, and washed repeatedly with warm water for more than or equal to 3 times. Then an organic phase was distilled and concentrated at reduced pressure, added with 150 mL of methanol, stirred for 1 h and allowed to stand still, and a large amount of precipitate was produced. The precipitate was filtered out, and a crude product S-BPEF was obtained. Then the crude product was recrystallized from an isopropanol solvent to obtain a pure target product.

### Preparation Example 2

A synthesis route of 9,9-bis[4-(2-hydroxyethylthio)-3-phenylphenyl]fluorene (S-BPPEF) is:

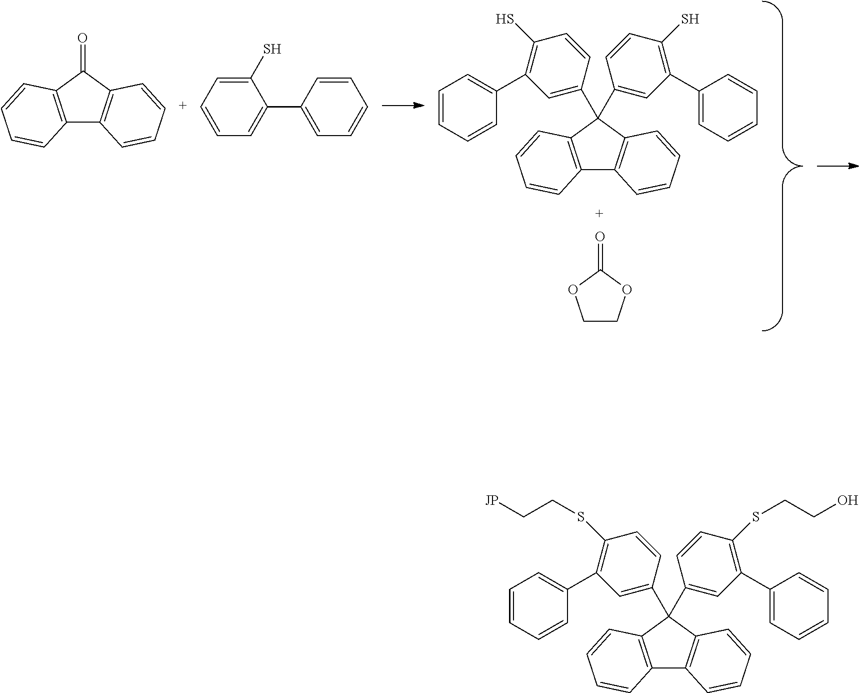

The 0.020 mol of 9-fluorenone, 0.160 mol of 2-phenylthiophenol and 0.002 g of β-mercaptopropionic acid were weighed out, and 50 mL of toluene was used as a reaction solvent. The reaction system was maintained in a nitrogen atmosphere. First, the reaction system was stirred at 60° C. until 9-fluorenone was completely dissolved, then 4.360 mL of concentrated sulfuric acid was added dropwise and the dropwise addition was completed within 0.5-1 h, and then the reaction system was heated to 80° C. and kept at the temperature to react for 5 h. After the reaction, 50 mL of toluene was added to dissolve a product, and an toluene organic phase was washed repeatedly with warm water for more than or equal to 3 times; the organic phase was collected, then distilled and concentrated at reduced pressure, added with 100 mL of methanol, stirred for 1 h, and filtered, and a crude product bis(phenylthiophenol)fluorene was obtained, and then recrystallized from isopropanol to obtain a pure product.

Then 0.010 mol of bis(phenylthiophenol)fluorene was weighed out and added with 0.022 mol of ethylene carbonate (EC), 50 mL of N,N-dimethylformamide (DMF) was used as a solvent, and the system was added with 0.001 mol of catalyst K₂CO₃ and heated to reflux to react for 3 h, then cooled to room temperature, added with 100 mL of deionized water and allowed to stand still, and a large amount of precipitate was produced. The precipitate was filtered out, washed with water and placed in a vacuum drying oven at 60° C. for 24 h, and a crude product was obtained. The crude product was recrystallized from toluene to obtain a pure target product.

### Preparation Example 3

A synthesis route of 9,9-bis[6-(2-hydroxyethylthio)naphthalene-2-yl]fluorene (S-BNEF) is:

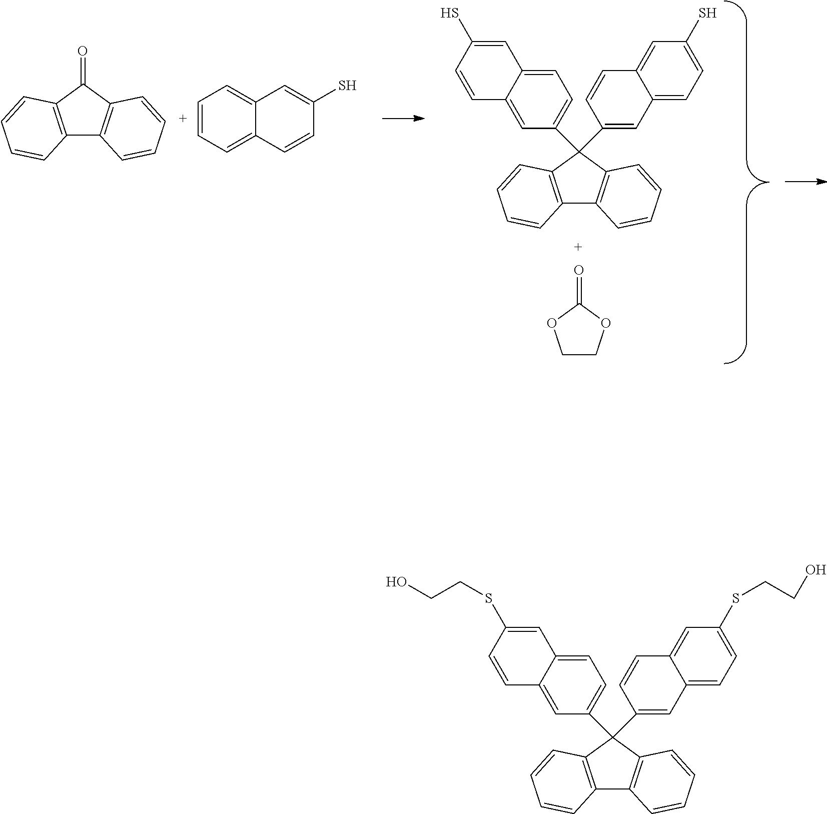

The 0.050 mol of 9-fluorenone, 0.400 mol of 2-naphthalenethiol and 0.004 g of β-mercaptopropionic acid were weighed out and 100 mL of toluene was used as a reaction solvent. The reaction system was maintained in a nitrogen atmosphere. First, the reaction system was stirred evenly at 60° C., then 10.900 mL of concentrated sulfuric acid was dropwise added, the dropwise addition was completed within 0.5-1 h, and then the reaction system was heated to 80° C., and kept at the temperature at slight negative pressure to react for 5 h. After the reaction, the reaction system was added with 80 mL of toluene and 150 mL of deionized water, and continued to be stirred for 1 h, and then a toluene organic phase was separated out, and washed repeatedly with warm water for more than or equal to 3 times. The organic phase was collected, then distilled and concentrated at reduced pressure, added with 100 mL of methanol, stirred for 1 h, and filtered, and a crude product bis(naphthalenethiol)fluorene was obtained, and then recrystallized from isopropanol to obtain a pure product.

Then 0.020 mol of the crude product bis(naphthalenethiol)fluorene was weighed out, added with 0.044 mol of ethylene carbonate (EC), 100 mL of N,N-dimethylformamide (DMF) as a solvent, and 0.002 mol of catalyst K₂CO₃, heated to reflux to react for 3 h, then cooled to room temperature, added with 150 mL of deionized water and allowed to stand still, and a large amount of precipitate was produced, filtered out, washed with water and placed in a vacuum drying oven at 60° C. for 24 h, and a crude product was obtained. The crude product was recrystallized from toluene to obtain a pure target product.

### Preparation Example 4

A synthesis route of 10,10-bis[4-(2-hydroxyethylthio)phenyl]anthrone (S-BHPA) is:

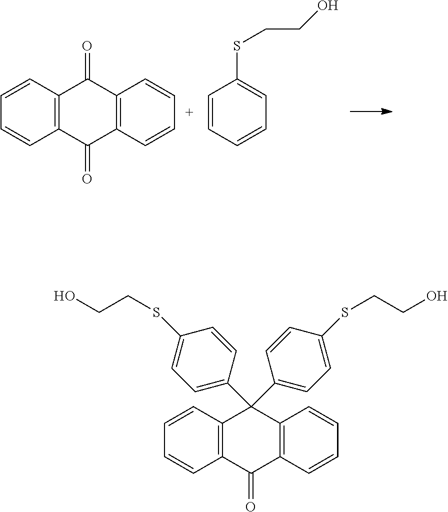

The 0.050 mol of anthraquinone, 0.300 mol of 2-(phenylthio)ethanol and 0.004 g of β-mercaptopropionic acid were weighed out. The reaction system was maintained in a nitrogen atmosphere. First, the reaction system was stirred at 40° C. until anthraquinone was completely dissolved, then 10.900 mL of concentrated sulfuric acid was dropwise added and the dropwise addition was completed within 0.5-1 h, then the reaction system was heated to 65° C., and kept at the temperature to react for 5 h. After the reaction, 100 mL of ethanol was added to dissolve a product, stirred at 50° C. for 1 h, and filtered to remove the unreacted raw materials, then 100 mL of toluene was added, warm water was used for washing repeatedly for more than or equal to 3 times, then an organic phase was distilled and concentrated at reduced pressure, added with 150 mL of methanol, stirred for 1 h and allowed to stand still, and a large amount of precipitate was produced and filtered out, and a crude product S-BHPA was obtained, and then recrystallized from ethanol to obtain a pure target product.

### Preparation Example 5

A synthesis route of 9,9-bis[6-(2-hydroxyethylthio)naphthalene-2-yl]thioxanthene (S-BNETH) is:

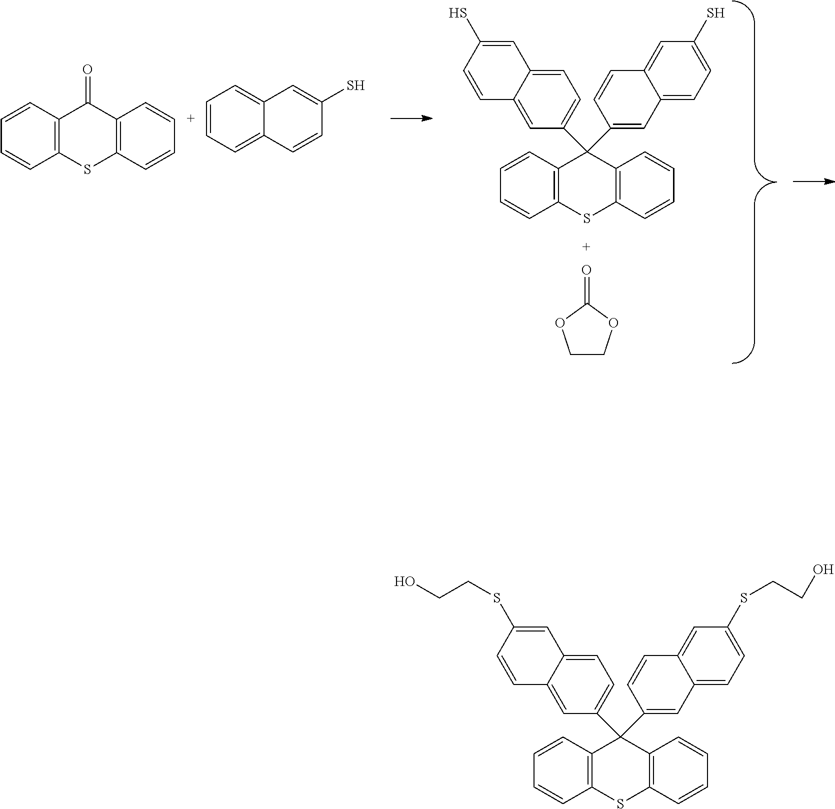

The 0.050 mol of thioxanthone, 0.400 mol of 2-naphthalenethiol and 0.004 g of β-mercaptopropionic acid were weighed out and 100 mL of toluene was used as a reaction solvent. The reaction system was maintained in a nitrogen atmosphere. First, the reaction system was stirred evenly at 40° C., then 10.900 mL of concentrated sulfuric acid was dropwise added, the dropwise addition was completed within 0.5-1 h, and then the reaction system was heated to 80° C., and kept at the temperature to react at slight negative pressure for 5 h. After the reaction, 80 mL of toluene and 150 mL of deionized water were added, the reaction system continued to be stirred for 1 h and separated to obtain a toluene organic phase, the toluene organic phase was washed repeatedly with warm water for more than or equal to 3 times, the organic phase was collected, then distilled and concentrated at reduced pressure, added with 100 mL of methanol, stirred for 1 h, and filtered, and a crude product bis(naphthalenethiol)thioxanthene was obtained, and then recrystallized from isopropanol to obtain a pure product.

Then 0.020 mol of the crude product bis(naphthalenethiol)thioxanthene was weighed out, added with 0.044 mol of ethylene carbonate (EC), 100 mL of N,N-dimethylformamide (DMF) as a solvent, and 0.002 mol of catalyst K₂CO₃, heated to reflux to react for 3 h, then cooled to room temperature, added with 150 mL of deionized water and allowed to stand still, and a large amount of precipitate was produced, filtered out, washed with water and placed in a vacuum drying oven at 60° C. for 24 h, and a crude product was obtained. The crude product was recrystallized from toluene to obtain a pure target product.

### Example 1

Preparation steps of the polycarbonate are as follows:

At room temperature, 0.030 mol of diphenyl carbonate (DPC) and 0.030 mol of S-BPEF were added into a 250 mL three-necked flask, and with the protection of a nitrogen atmosphere, the raw materials were melted, heated to a transesterification temperature of 150° C., and then added with a sodium hydroxide catalyst, wherein a usage amount of the sodium hydroxide catalyst was 0.005 mol % of a usage amount of diphenyl carbonate. A transesterification reaction was performed with stirring at 150° C. for 3 h to obtain a polycarbonate prepolymer; then the temperature was gradually increased to a polycondensation temperature of 240° C. and the pressure of the reaction system was gradually reduced to a pressure of less than 50 Pa, and the polycondensation reaction was performed for 0.5 h, and after the reaction was completed, nitrogen was introduced into the reactor to return atmospheric pressure. Then a product was dissolved in dichloromethane and precipitated by methanol to obtain the polycarbonate material.

### Example 2

Preparation steps of the polycarbonate are as follows:

The same operations as in Example 1 were performed except that 0.030 mol of DPC, 0.015 mol of S-BPEF, 0.006 mol of BPEF and 0.009 mol of S-BNE were used as raw materials.

### Example 3

Preparation steps of the polycarbonate are as follows:

The same operations as in Example 1 were performed except that 0.030 mol of DPC and 0.030 mol of S-BPPEF were used as raw materials.

### Example 4

Preparation steps of the polycarbonate are as follows:

The same operations as in Example 1 were performed except that 0.030 mol of DPC, 0.021 mol of S-BPPEF, 0.0045 mol of BPA and 0.0045 mol of S-BNE were used as raw materials.

### Example 5

Preparation steps of the polycarbonate are as follows:

The same operations as in Example 1 were performed except that 0.030 mol of DPC and 0.030 mol of S-BNEF were used as raw materials.

### Example 6

Preparation steps of the polycarbonate are as follows:

The same operations as in Example 1 were performed except that 0.030 mol of DPC, 0.0275 mol of S-BNEF, 0.009 mol of BPEF and 0.0045 mol of S-BNE were used as raw materials and the polycondensation reaction was performed for 1 h.

### Example 7

Preparation steps of the polycarbonate are as follows:

The same operations as in Example 1 were performed except that 0.030 mol of DPC, 0.018 mol of S-BHPA, 0.006 mol of BPEZ and 0.006 mol of S-BNE were used as raw materials and the polycondensation reaction was performed at 260° C.

### Example 8

Preparation steps of the polycarbonate are as follows:

At room temperature, 0.030 mol of DPC, 0.012 mol of S-BNEF, 0.012 mol of S-BNETH and 0.006 mol of BPEF were added into a 250 mL three-necked flask, and with the protection of a nitrogen atmosphere, the raw materials were melted, heated to a transesterification temperature of 150° C., and then added with a sodium hydroxide catalyst, wherein a usage amount of the sodium hydroxide catalyst was 0.005 mol % of a usage amount of diphenyl carbonate. A transesterification reaction was performed with stirring at 150° C. for 3 h to obtain a polycarbonate prepolymer; then the temperature was gradually increased to a polycondensation temperature of 240° C. and the pressure of the reaction system was gradually reduced to a pressure of less than 50 Pa, the polycondensation reaction was performed for 0.5 h, and after the reaction was completed, nitrogen was introduced into the reactor to return atmospheric pressure. Then a product was dissolved in dichloromethane and precipitated by methanol to obtain the polycarbonate material.

### Example 9

Preparation steps of the polycarbonate are as follows:

The same operations as in Example 8 were performed except that the transesterification reaction was performed at a temperature of 120° C. for a period of 0.2 h, the polycondensation reaction was performed at a temperature of 200° C., and a usage amount of the catalyst was 0.001 mol % of a usage amount of diphenyl carbonate.

### Example 10

Preparation steps of the polycarbonate are as follows:

The same operations as in Example 8 were performed except that the polycondensation reaction was performed at a temperature of 260° C. for a period of 5 h.

### Example 11

Preparation steps of the polycarbonate are as follows:

The same operations as in Example 8 were performed except that the transesterification reaction was performed at a temperature of 190° C. for a period of 5 h.

### Example 12

Preparation steps of the polycarbonate are as follows:

The same operations as in Example 8 were performed except that the transesterification reaction was performed at a temperature of 190° C., the polycondensation reaction was performed for a period of 1.5 h, and the catalyst was tetraethylammonium hydroxide.

### Comparative Example 1

The same operations as in Example 1 were performed except that 0.030 mol of DPC and 0.300 mol of BPA were used as raw materials.

### Comparative Example 2

The same operations as in Example 1 were performed except that 0.030 mol of DPC and 0.300 mol of BPEF were used as raw materials.

### Comparative Example 3

The same operations as in Example 1 were performed except that 0.030 mol of DPC and 0.300 mol of BPEZ were used as raw materials.

The properties of the polycarbonate provided by the Examples 1-12 and Comparative Examples 1-3 are tested, which comprise the weight average molecular weight Mw, refractive index and Abbe number, and the test data are shown in Table 1.

It can be seen from the test results in Table 1 that compared with the polycarbonate in prior art, the polycarbonate having a specific repeating unit provided in the present application has significantly higher refractive index, and the polycarbonate has a refractive index as high as 1.673-1.794 and an Abbe number of 15-20 and shows no obvious birefringence phenomenon, which has excellent optical performance.

TABLE 1

| | | | | | | | | | | Physical property | | |
|---|---|---|---|---|---|---|---|---|---|---|---|---|
| | Composition proportion (mol %) | | | | | | | | | | Refractive | Abbe |
| — | S- | S- | S- | S- | S- | | | | S- | M_{w} | index | number |
| — | BPEF | BPPEF | BNEF | BHPA | BNETH | BPA | BPEF | BPEZ | BNE | (g/mol) | n_{D} | V_{D} |
| Example 1 | 100 | | | | | | | | | 72300 | 1.707 | 16.3 |
| Example 2 | 50 | | | | | | 20 | | 30 | 85600 | 1.683 | 18.2 |
| Example 3 | | 100 | | | | | | | | 70100 | 1.725 | 15.4 |
| Example 4 | | 70 | | | | 15 | | | 15 | 81500 | 1.696 | 17.7 |
| Example 5 | | | 100 | | | | | | | 77200 | 1.747 | 15.1 |
| Example 6 | | | 55 | | | | 30 | | 15 | 82800 | 1.7026 | 16.6 |
| Example 7 | | | | 60 | | | | 20 | 20 | 64300 | 1.673 | 24.1 |
| Example 8 | | | 40 | | 40 | | 20 | | | 99800 | 1.794 | 15.4 |
| Example 9 | | | 40 | | 40 | | 20 | | | 30000 | 1.793 | 15.5 |
| Example 10 | | | 40 | | 40 | | 20 | | | 63100 | 1.793 | 15.5 |
| Example 11 | | | 40 | | 40 | | 20 | | | 116000 | 1.794 | 15.4 |
| Example 12 | | | 40 | | 40 | | 20 | | | 137800 | 1.794 | 15.4 |
| Comparative | | | | | | 100 | | | | 44522 | 1.579 | 30.8 |
| Example 1 | | | | | | | | | | | | |
| Comparative | | | | | | | 100 | | | 78100 | 1.635 | 23.4 |
| Example 2 | | | | | | | | | | | | |
| Comparative | | | | | | | | 100 | | 82400 | 1.580 | 31.2 |
| Example 3 | | | | | | | | | | | | |

The above is only preferable examples of the present application, which are not intended to limit the present application. Any modifications, equivalent substitutions and improvements, which are made within the spirit and principles of the present application, shall be comprised in the protection scope of the present application.

What is claimed is:

1. A polycarbonate, which comprises at least one structural unit selected from a structural unit represented by Formula (I) and a structural unit represented by Formula (II): 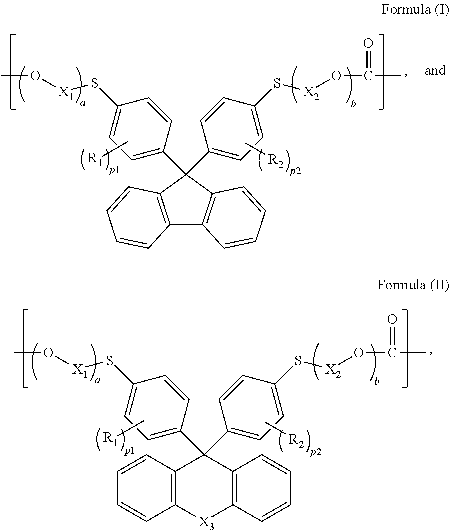
in Formula (I) and Formula (II), X₁ and X₂ each independently represent a substituted or unsubstituted, linear or branched, alkylene group having 1-8 carbon atoms; X₃ represents oxygen, sulfur, nitrogen, a carbonyl group, a substituted or unsubstituted, linear or linear, alkylene group having 1-10 carbon atoms, or a substituted or unsubstituted cycloalkylene group having 3-10 carbon atoms; R₁ and R₂ each independently represent hydrogen, halogen, a hydroxyl group, an ester group, a cyano group, an amino group, a thiol group, a substituted or unsubstituted, linear or branched, alkyl group having 1-6 carbon atoms, a substituted or unsubstituted cycloalkyl group having 3-10 carbon atoms, a substituted or unsubstituted olefin group having 2-6 carbon atoms, a substituted or unsubstituted alkoxy group having 1-6 carbon atoms, a substituted or unsubstituted, aryl or polycyclic aryl group having 6-30 carbon atoms, a substituted or unsubstituted, heteroaryl or polycyclic heteroaryl group having 3-30 carbon atoms, or an atom or atomic group which is used to replace the above groups; p1 and p2 are each independently selected from integers from 1 to 3; and a and b are each independently selected from integers from 0 to 5.

2. The polycarbonate according to claim 1, wherein based on a total number of moles of all repeating structural units of the polycarbonate, the at least one structural unit selected from the structural unit represented by Formula (I) and the structural unit represented by Formula (II) has a content proportion of 5-100 mol %.

3. The polycarbonate according to claim 2, wherein the polycarbonate further comprises a repeating structural unit represented by Formula (III) or Formula (IV): 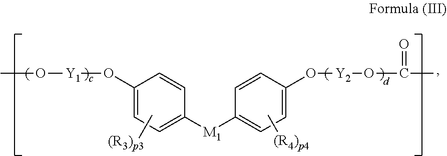
in Formula (III), Y₁ and Y₂ each independently represent a substituted or unsubstituted, linear or branched, alkylene group having 1-8 carbon atoms; c and d are each independently selected from integers from 0 to 5; M₁ independently represents any one of a single bond, O, S, a linear or linear alkylene group having 1-5 carbon atoms, 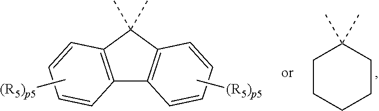
wherein a broken line represents a linkage site for a group; R₃, R₄, R₅ and R₆ are each independently selected from hydrogen, halogen, a hydroxyl group, an ester group, a cyano group, an amino group, a thiol group, a substituted or unsubstituted, linear or branched, alkyl group having 1-6 carbon atoms, a substituted or unsubstituted cycloalkyl group having 3-10 carbon atoms, a substituted or unsubstituted olefin group having 2-6 carbon atoms, a substituted or unsubstituted alkoxy group having 1-6 carbon atoms, a substituted or unsubstituted, aryl or polycyclic aryl group having 6-30 carbon atoms, a substituted or unsubstituted, heteroaryl or polycyclic heteroaryl group having 3-30 carbon atoms, or an atom or atomic group which is used to replace the above groups; p3, p4, p5 and p6 are independently selected from integers from 1 to 3; 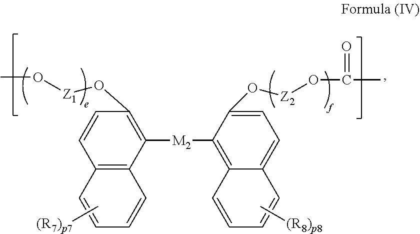
in Formula (IV), M₂ independently represents a single bond, O, or S; Z₁ and Z₂ each independently represent a substituted or unsubstituted, linear or branched, alkylene group having 1-8 carbon atoms; e and f are independently selected from integers from 0 to 5; R₇ and R₅ are each independently selected from hydrogen, halogen, a hydroxyl group, an ester group, a cyano group, an amino group, a thiol group, a substituted or unsubstituted, linear or branched, alkyl group having 1-6 carbon atoms, a substituted or unsubstituted cycloalkyl group having 3-10 carbon atoms, a substituted or unsubstituted olefin group having 2-6 carbon atoms, a substituted or unsubstituted alkoxy group having 1-6 carbon atoms, a substituted or unsubstituted, aryl or polycyclic aryl group having 6-30 carbon atoms, a substituted or unsubstituted, heteroaryl or polycyclic heteroaryl group having 3-30 carbon atoms, or an atom or atomic group which is used to replace the above groups; p7 and p8 are independently selected from integers from 1 to 3.

4. The polycarbonate according to claim 3, wherein based on a total number of moles of all repeating structural units of the polycarbonate, the at least one structural unit selected from the structural unit represented by Formula (I) and the structural unit represented by Formula (II) has a content proportion of 30-85 mol %, and at least one structural unit selected from the structural unit represented by Formula (III) and the structural unit represented by Formula (IV) has a content proportion of 15-70 mol %.

5. The polycarbonate according to claim 2, wherein the polycarbonate has a refractive index of 1.673-1.794 and a glass transition temperature of 135-200° C.

6. A preparation method for polycarbonate, wherein a dihydroxyl compound and diaryl or dialkyl carbonate are used as raw materials, wherein the dihydroxyl compound comprises at least one dihydroxyl compound selected from Formula (1), Formula (2), Formula (3) and Formula (4), and a polycarbonate is synthesized by melt transesterification and polycondensation reactions at atmospheric pressure in a nitrogen atmosphere; the preparation method comprises melting the raw materials, then heating to a transesterification temperature of 120-190° C., and performing a transesterification reaction for 0.2-5 h by adding a catalyst to obtain a polycarbonate prepolymer; then gradually heating to a polycondensation temperature of 200-260° C., wherein a pressure of the reaction system is less than 50 Pa, and performing a polycondensation reaction for 0.2-5 h, so as to obtain a polycarbonate copolymer after the reaction, which has a weight average molecular weight of 3.0×10⁴-21.6×10⁴ g/mol; 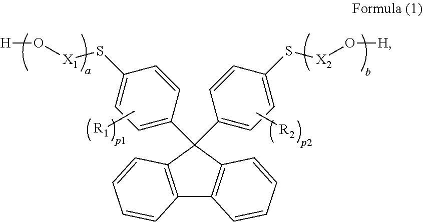
wherein X₁, X₂, R₁, R₂, p1, p2, a and b are each independently defined by the same limitation to Formula (I); 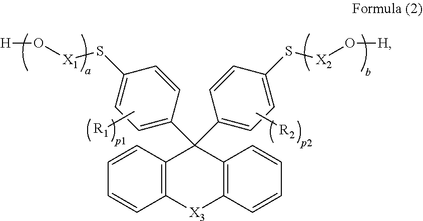
wherein X₁, X₂, X₃, R₁, R₂, p1, p2, a and b are each independently defined by the same limitation to Formula (II); 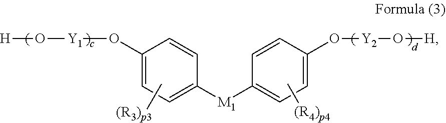
wherein M₁, Y₁, Y₂, R₃, R₄, p3, p4, c and d are each independently defined by the same limitation to Formula (III); 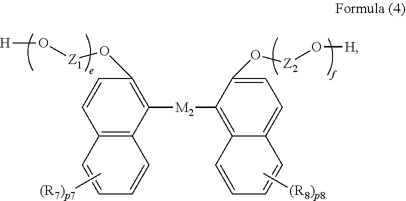
wherein M₂, Z₁, Z₂, R₇, R₈, p7, p8, e and f are each independently defined by the same limitation to Formula (IV).

7. The preparation method according to claim 6, wherein the catalyst is selected from an ionic liquid catalyst or a metal catalyst, wherein a cation in the ionic liquid catalyst is selected from any one of an imidazole cation, a quaternary ammonium cation, a quaternary phosphonium cation, a piperidine cation and a pyridine cation; the metal catalyst is at least one of lithium acetylacetonate, sodium acetylacetonate, potassium acetylacetonate, magnesium acetylacetonate, calcium acetylacetonate, zinc acetylacetonate, dibutyltin oxide, tetrabutyl titanate, tetraisopropyl titanate, a carbonate salt, an acetate salt, an alkali metal, an alkaline earth metal, 1,5,7-triazabicyclo[4.4.0]dec-5-ene (TBD) or 1,8-diazabicyclo[5.4.0]-7-undecene (DBU); a usage amount of the catalyst is 1×10⁻⁷-5×10⁻⁴ of an amount of substance of the diaryl or dialkyl carbonate compound.

8. The preparation method according to claim 6, wherein the diaryl or dialkyl carbonate compound comprises any one or a combination of at least two of diphenyl carbonate, dimethyl carbonate, diethyl carbonate, dipropyl carbonate, dibutyl carbonate, dipentyl carbonate and dioctyl carbonate; the dihydroxyl compound comprises any one or a combination of at least two of Formula (1), Formula (2), Formula (3), Formula (4), isosorbide, isomannide, isoiditol, 1,5-pentanediol, 1,6-hexanediol, 1,7-heptanediol, 1,3-cyclopentanediol, 1,3-cyclohexanediol, 1,4-cyclohexanediol, 1,2-cyclohexanedimethanol, 1,4-cyclohexanedimethanol, diethylene glycol, triethylene glycol, tetraethylene glycol, hydrogenated dioleyl diol, 1,5-naphthalenedimethanol, 2,5-norbornanedimethanol or 4,8-bis(hydroxymethyl)tricyclodecane; a molar ratio of the dihydroxyl compound to the diaryl or dialkyl carbonate is 1:(0.97-5).

9. (canceled)

10. An optical product, which contains the polycarbonate according to claim 1.

11. An optical product, which contains the polycarbonate prepared by the preparation method according to claim 6.
